(19) United States
(12) Patent Application Publication
(10) Pub. No.: US 2024/0242169 A1
(43) Pub. Date: Jul. 18, 2024

(54) SYSTEM AND METHODS FOR AUTOMATED SHIPMENT BOOKING

(71) Applicant: Target Brands, Inc., Minneapolis, MN (US)

(72) Inventors: BIDESH ROY, Minneapolis, MN (US); PATRICK MCNEIL, Minneapolis, MN (US); PHI LE, Minneapolis, MN (US); EDISON FIGUEROA, Minneapolis, MN (US); LOGESH KUMAR SELVAMANI, Hopkins, MN (US)

(21) Appl. No.: 18/154,593

(22) Filed: Jan. 13, 2023

(51) Int. Cl. G06Q 10/0834; G06Q 10/0832; G06Q 50/30

(52) U.S. Cl. CPC G06Q 10/08345; G06Q 10/0832; G06Q 50/30

(57) ABSTRACT

The present application relates to a shipment booking application designed to automate a shipment creation process, organize shipping carriers to pick up shipments, and synchronize delivery to distribution centers. The disclosed system may automate shipment creation process by computing an optimal time window to schedule each pickup, organize shipping carriers to pick up shipments by confirming computed time windows with vendors, and synchronize delivery to distribution centers by calculating schedules based on delivery expectation of purchase orders. To improve predictability and consistency of deliveries received at distribution centers, example embodiments of the disclosed system may synchronize multiple systems with the goal to optimize shipment booking first for on-time delivery rather for than first for transportation costs, in some examples.

### BACKGROUND

Conventionally, transit time for an enterprise, such as a retail enterprise, to have its purchase orders shipped from vendors to distribution centers (or warehouses, etc.) is subject to significant variability. In some instances, an enterprise may prioritize a selection of a transportation mode (e.g., heavy truck, rail, air, water, light truck, etc.) by cost. That is, the enterprise may choose the transportation mode for a particular purchase order of items which is the cheapest mode of transportation between any two points of the transit. In an enterprise system which is configured such that vendors propose pickup time windows for purchase orders, it can be difficult for the enterprise to determine when a delivery to a given distribution center or warehouse might occur. Inventory management systems for enterprises may rely on expected delivery time when managing stores, sales, supply chains, inventory, and placing purchase orders, and when the delivery time is not able to be accurately predicted or when a predicted delivery time is not met, there is an apparent disconnect between first-mile logistics and inventory management.

### SUMMARY

The present application relates to a shipment booking application designed with intelligence to automate the shipment creation process, assist in organize shipping carriers to pick up shipments, and synchronize on time delivery to distribution centers.

The disclosed system may automate a shipment creation process by computing an optimal time window to schedule each pickup, assist in organize shipping carriers to pick up shipments (including, in some examples, confirming computed time windows with vendors), and synchronize delivery to distribution centers by calculating schedules based on delivery expectation of purchase order destinations.

Accordingly, the present application describes a computing system, including at least one processor and at least one memory storing computer-executable instructions for optimizing shipment scheduling. The computer-executable instructions, when executed by at least one processor, may cause the computing system to: receive an electronic communication including shipment data associated with a purchase order from a purchase order application, the shipment data being associated with a shipment of items defined on the purchase order (where the shipment data comprises one or more of: an earliest eligible pickup date, a shipment receipt date, a vendor, and a destination); and automatically analyze a plurality of transportation modes to select an optimal transportation mode from the plurality of transportation modes, wherein each of the plurality of transportation modes has associated a cost, a capacity, and a shipping time (transit time). Selecting the optimal transportation mode may be based on: defining a latest pickup date for each of the plurality of transportation modes, wherein the latest pickup date is defined by subtracting the shipping time from the shipment receipt date; calculating a pickup window for each of the plurality of transportation modes, wherein the calculation of the pickup window is based on the time between the ship begin date and the latest pickup date; determining whether the latest pickup date is after the earliest eligible pickup date; and from among each transportation mode of the plurality of transportation modes for which the latest pickup date is after the earliest eligible pickup date, selecting the optimal transportation mode which has a lowest associated cost. The instructions may also cause the computing system to generate a user interface accessible to the vendor, the user interface including at least pickup information comprising the optimal transportation mode and the pickup window; and to transmit the pickup information to the vendor for display on the vendor computing system via the user interface, in response to a request from a vendor computing system associated with the vendor.

In some examples, a disclosed method may comprise: receiving an electronic communication including shipment data associated with a purchase order from a purchase order application, the shipment data being associated with a shipment of items defined on the purchase order (where the shipment data comprises one or more of: an earliest eligible pickup date, a shipment receipt date, a vendor, and a destination); and automatically analyzing a plurality of transportation modes to select an optimal transportation mode from the plurality of transportation modes, wherein each of the plurality of transportation modes has associated a cost, a capacity, and a shipping time. Selecting the optimal transportation mode may be based on: determining whether each of the transportation modes is adequate to transport the shipment of items, based on the item handling characteristics; for each transportation mode of the plurality of transportation modes which is adequate to transport the shipment of items, defining a latest pickup date, wherein the latest pickup date is defined by subtracting the shipping time from the shipment receipt date; calculating a pickup window for each of the plurality of transportation modes which is adequate to transport the shipment of items, wherein the calculation of the pickup window is based on the time between the ship begin date and the latest pickup date; and determining whether the latest pickup date is after the earliest eligible pickup date; and from among each transportation mode of the plurality of transportation modes which is adequate to transport the shipment of items, selecting the optimal transportation mode which has a lowest associated cost. The method may also include generating a user interface accessible to the vendor, the user interface including at least pickup information comprising the optimal transportation mode and the pickup window; and transmitting the pickup information to the vendor for display on the vendor computing system via the user interface, in response to a request from a vendor computing system associated with the vendor.

In some examples, a disclosed computing system may include at least one processor and at least one memory storing computer-executable instructions for optimizing shipment scheduling. The computer-executable instructions, when executed by the at least one processor, may cause the computing system to: receive a first electronic communication including shipment data associated with a purchase order from a purchase order application, the shipment data being associated with a shipment of items defined on the purchase order (where the shipment data comprises one or more of: an earliest eligible pickup date, a shipment receipt date, a vendor, a destination, and item handling characteristics associated with the shipment of items, including a dimension of the shipment of items). The instructions may further cause the computing system to receive a second electronic communication including a plurality of transportation modes, wherein each of the plurality of transportation modes is available to transport the shipment of items from the vendor to the destination; and automatically analyze the plurality of transportation modes to select an optimal transportation mode from the plurality of transportation modes, wherein each of the plurality of transportation modes has associated a cost, a capacity, and a shipping time. Selecting the optimal transportation mode is based on: defining a latest pickup date for each of the plurality of transportation modes, wherein the latest pickup date is defined by subtracting the shipping time from the shipment receipt date; calculating a pickup window for each of the plurality of transportation modes, wherein the calculation of the pickup window is based on the time between the ship begin date and the latest pickup date; determining whether the latest pickup date is after the earliest eligible pickup date; and from among each transportation mode of the plurality of transportation modes for which the latest pickup date is after the earliest eligible pickup date, selecting the optimal transportation mode which has a lowest associated cost. The instructions may further cause the computing system to generate a user interface accessible to the vendor, the user interface including at least pickup information comprising the optimal transportation mode and the pickup window; transmit the pickup information to the vendor for display on the vendor computing system via the user interface (in response to a request from a vendor computing system associated with the vendor); receive a request from the from the vendor computing system via the user interface to change the dimension of the shipment of items; automatically evaluate an effect of the requested change on the adequacy of the optimal transportation mode; determine, based on the evaluation, that the requested change will cause the optimal transportation mode to be inadequate to transport the shipment of items; determine that, from among each transportation mode of the plurality of transportation modes for which the latest pickup date is after the earliest eligible pickup date, none of the plurality of transportation modes is adequate to transport the shipment of items, based on the requested change; update the pickup information, wherein updating the pickup information includes generating a notification to the vendor that the requested change to the dimension is rejected; and automatically transmit the notification to the vendor, via a vendor application programming interface, for display on the vendor computing system via the user interface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example supply chain network in which a system for optimizing shipment scheduling may be implemented, according to an example.

FIG. 2 illustrates an example supply chain network in which a system for optimizing shipment scheduling may be implemented, according to an example.

FIG. 3 illustrates an example system for optimizing shipment scheduling, according to an example.

FIG. 4 illustrates example timelines for optimizing shipment scheduling, according to an example.

FIG. 5 illustrates an example method for optimizing shipment scheduling, according to an example.

FIG. 6 illustrates an example method for optimizing shipment scheduling, according to an example.

FIG. 7A illustrates an example method for optimizing shipment scheduling, according to an example.

FIG. 7B illustrates an example method for optimizing shipment scheduling, according to an example.

FIG. 8 illustrates a vendor user interface, according to an example.

FIG. 9 illustrates a vendor user interface, according to an example.

FIG. 10 illustrates a vendor user interface, according to an example.

FIG. 11 illustrates an example block diagram of a computing system.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present application relates to a shipment booking application designed to automate a shipment creation process, organize shipping carriers to pick up shipments, and synchronize delivery to distribution centers. The disclosed system may automate shipment creation process by computing an optimal time window to schedule each pickup, organize shipping carriers to pick up shipments by confirming computed time windows with vendors, and synchronize delivery to distribution centers by calculating schedules based on delivery expectation of purchase orders.

To improve predictability and consistency of deliveries received at distribution centers, some example embodiments of the disclosed system may synchronize multiple systems with the goal to optimize shipment booking first for on-time delivery rather for than first for transportation costs, in some examples. In some examples, the system may achieve such improved predictability and consistency by having the enterprise set when pickups need to occur. A pickup time window may be determined by provisioning modes of transportation and working backwards from the expected delivery time of a purchase order placed by the retail business to the vendor. In some examples, the system also may improve visibility of shipments being managed, at least by communicating with the vendor about the proposed pickup time window and displaying the status of a shipment real-time to the retail business.

In some examples, the disclosed system receives input data from users or APIs. In some examples, the input data may include information about a purchase order, a vendor with its location, items of a shipment, a location receiving the shipment, transit times, and other location attributes. With the input data, the system may create a shipment instance to be prepared for transportation by calculating a pickup time window between two dates and a delivery time window between two dates. Combining the pickup time window, delivery time window, locations information, shipment information, and transit times information, the system is then configured to optimize a transportation plan. The transportation plan may include assignment of carriers, modes of transportation. In some examples, the transportation plan may align the pickup date to the delivery date required by the location receiving the shipment.

In further examples, the disclosed system may communicate with the user and vendors about carrier assignment and the calculated pickup time window. For example, the system may track different origin locations that are selected and prompt a user to confirm or fix the data. In some examples, vendors may update data about the shipment through the disclosed system. The disclosed system may schedule delivery and pickup appointments for a shipment. After appointments are scheduled, disclosed system may then execute and track them.

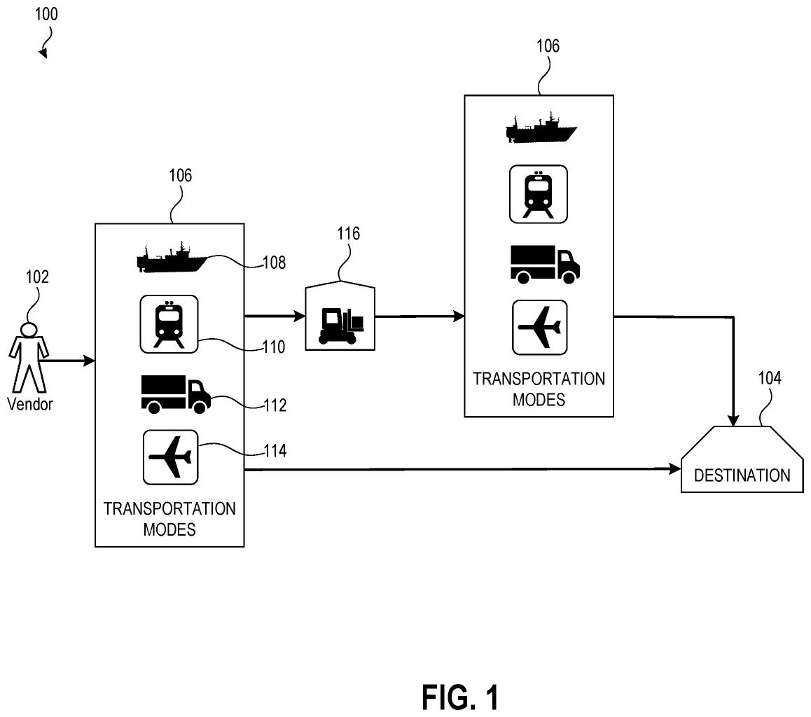

These and other examples will be explained in more detail below with respect to FIG. 1-FIG. 11.

FIG. 1 illustrates an example supply chain network in which a system for optimizing shipment scheduling may be implemented. As will be described in more detail below, the supply chain network 100 may include a vendor 102, a destination 104, a plurality of transportation modes 106 (including, for example, by cargo ship 108, by rail 110, by land truck 112, and/or by air freight 114), and consolidator 116.

In an example, an enterprise, such as a retail enterprise, may acquire items (for example, retail, produce, or other goods to be sold) from one or more vendors such as vendor 102. In some examples, vendor 102 may be a product supplier, distributor, manufacturer, grower, packager, processor, or courier. In some examples, vendor 102 may reside overseas from the enterprise. In some examples, vendor 102 may reside domestically with the enterprise.

In some examples, the enterprise may require that the items arrive at a specific destination 104. In some examples, destination 104 may be a retail store or other point of sale, a warehouse or other storage facility, or other destination associated with the enterprise.

In some examples, one or more of a plurality of transportation modes 106 may be available to the enterprise to transport items from vendor 102 to destination 104. In some examples, cargo ship 108 may be representative of any appropriate method of moving products over a body of water, including cargo vessels, bulk vessels, tankers, livestock vessels, refrigerated vessels, freighters, barges, container ships, feeder vessels, or other appropriate water transportation methods.

In some examples, rail 110 may be representative of any appropriate method of moving products over land on a vehicle via a rail or track system, including freight trains.

In some examples, truck 112 may be representative of various types of land transportation vehicles, including container trucks, vans, semi-trailer trucks, box trucks, flatbed trucks, last-mile delivery vehicles, or others.

In some examples, air freight 114 may be representative of any appropriate air transportation vehicles, including airplanes, jets, or other appropriate air vessels.

In some examples, one or more transportation modes 106 may transport the item(s) directly to the destination 104. In some examples, destination 104 may be a retail store or other point of sale or a warehouse (which may supply retail stores, online orders, or others as appropriate). In some examples, destination 104 requires items from vendor 102 at or by a specific date/time, as will be discussed in more detail below.

In some examples, one or more transportation modes 106 may transport the item(s) to an intermediate consolidator 116. In some examples, consolidator facility may be representative of any appropriate facility, including a warehouse, mixing center, sortation center, distribution center, pack and ship warehouse, or other appropriate facility type. In some examples, a consolidator may be necessary to palletize items, separate items out from pallets, remove or combine items into different packages or groupings, or to combine different products into appropriate shipments or different shipping containers.

In some examples, one or more transportation modes 106 may transport the item(s) from the consolidator 116 to the destination 104. In some examples, an item may be transported to more than one consolidator 116 before reaching its destination 104.

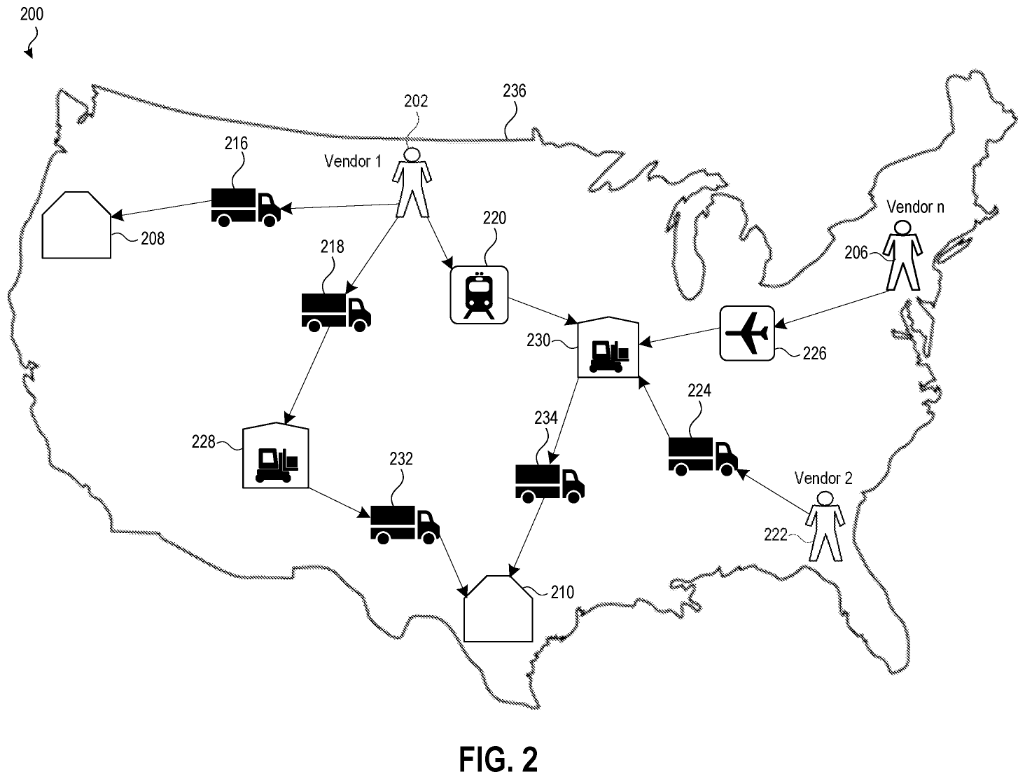

FIG. 2 illustrates an example further supply chain network in which a system for optimizing shipment scheduling may be implemented. In an example, supply chain network 200 may include one or more vendor(s) (for example, vendor 1 202, vendor 2, 222, and vendor n 206; which may be representative of vendor 102 above), one or more consolidators 220, 228 (which may be representative of consolidator 116 above), one or more transportation modes (including trucks 216, 218, 224, 232, 234; rail 220, and air freight 226; which may be representative of transportation modes 106 above), one or more destinations 208, 210 (which may be representative of destination 104 above), and geographical area 236.

In some examples, an enterprise may operate within one or more geographical areas 236. In some examples, an enterprise may receive items from vendors within the same geographical area, or from different geographical areas.

In some examples, an enterprise may receive/source similar or different items from more than one vendor (for examples, vendor 1 202, vendor 2, 222, and vendor n 206).

In some examples, a vendor may ship items to destinations directly. For example, Vendor 1 202 may ship one or more items to destination 208 via truck 216. In some examples, a vendor may ship items to one or more consolidators via a first transportation mode, and then the consolidator may ship the items to the destination via a second transportation mode, which is the same as the first transportation mode. For example, vendor 1 202 may ship items to consolidator 228 via truck 218, and consolidator 228 may ship the items to destination 210 via truck 232. Similarly, vendor 2 222 may ship items to consolidator 230 via truck 224, and consolidator 230 may ship the items to destination 210 via truck 234. In some examples, a vendor may ship items to one or more consolidators via a first transportation mode, and then the consolidator may ship the items to the destination via a second transportation mode, which is different from the first transportation mode. For example, vendor 1 202 may ship items to consolidator 130 via rail 220, and consolidator 230 may ship the items to destination 210 via truck 234. Similarly, vendor n 206 may ship items to consolidator 230 via air freight 226, and consolidator 230 may ship the items to destination 210 via truck 234. Each of these varied delivery modes may require different amounts of time, or have different expected amounts of time, for delivery of items from vendor to destination.

In some examples, a vendor (or consolidator) may only have a single transportation mode available to it to ship items (may be configured to only package and/or ship items for a single transportation mode). For example, vendor 2 222 may have truck 224 available. Similarly, vendor n 206 may have air freight 226 available. In some examples, a vendor (or consolidator) may have multiple vendors available to it for shipping items. For example, vendor 1 202 may be configured to ship items via trucks 216, 218, or rail 220. In some examples, a consolidator (or destination) may be configured to receive items via a single transportation mode. For example, consolidator 228 may be configured to receive items via truck 218. In some examples, a consolidator (or destination) may be configured to receive items via multiple transportation modes. For example, consolidator 230 may be configured to receive items via rail 220, air freight 226, and truck 224.

In some examples, a vendor may ship items to a single destination or consolidator. For example, vendor n 206 may ship items to consolidator 230, and vendor 2 222 may ship items to consolidator 230. In some examples, a vendor may ship items to multiple destinations or consolidators. For example, vendor 1 201 may ship items to destination 208, consolidator 228, and/or consolidator 230. In some examples, a consolidator may receive items from a single vendor. For example, consolidator 228 may receive items from vendor 1 202. In some examples, a consolidator may receive items from multiple vendors. For example, consolidator 230 may receive items from vendor 1 202, vendor 2 222, and/or vendor n 206. In some examples, a consolidator may ship items to a single destination (or downstream consolidator). For example, consolidator 228 may ship items to destination 210. In some examples, a consolidator may ship items to multiple destinations (or downstream consolidators). In some examples, a destination may receive items from a single vendor or consolidator. For example, destination 208 may receive items from vendor 1 202. In some examples, a destination may receive items from multiple vendors or multiple consolidators. For example, destination 210 may receive items originating from vendor 1 202, vendor 2 222, and vendor n 206, which may pass through consolidator 228 or consolidator 230.

As described below, each vendor may need an amount of time to prepare an item for shipment, each transportation mode may have an associated transit time, each consolidator may have an associated processing time, and each destination may have a target date by which the item is to be received.

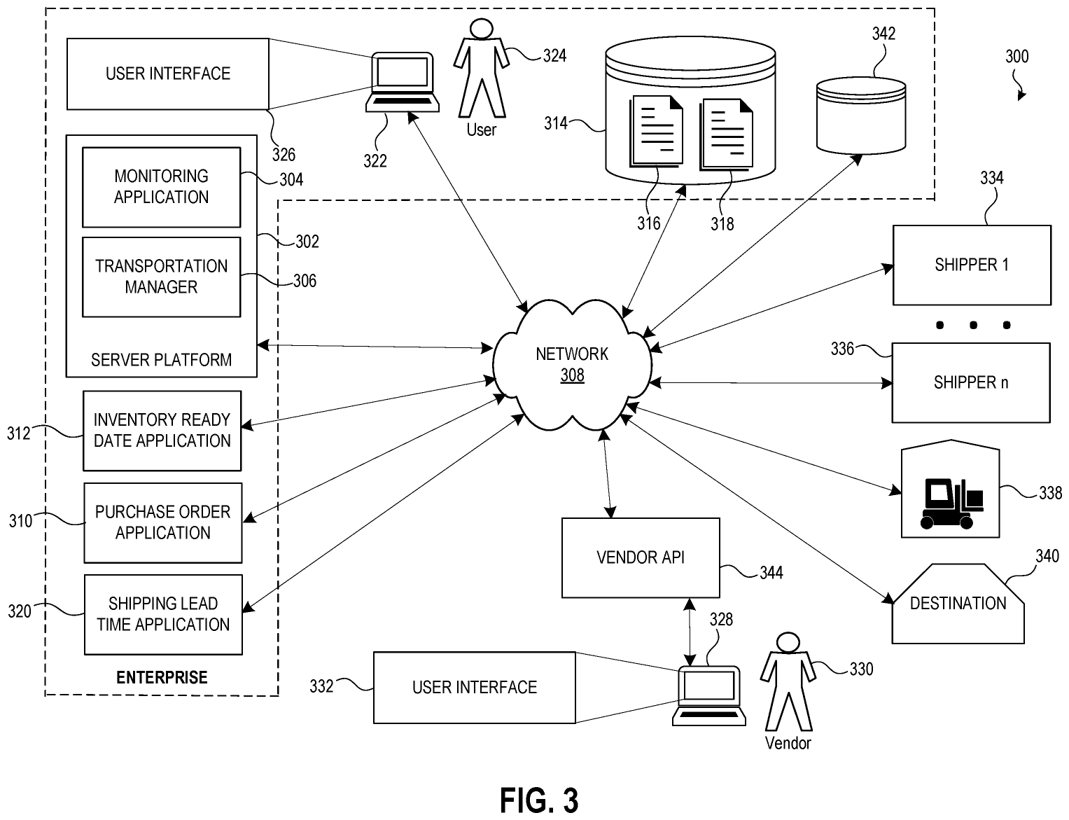

FIG. 3 illustrates an example system 300 for optimizing shipment scheduling. In some examples, system 300 may include one or more of each of: a server platform 302, monitoring application 304, transportation manager 306, network 308, purchase order application 310, inventory ready data application 312, database 314, location information 316, vendor processing information 318, shipping lead time application 320, user device 322, user 324, user interface 326, vendor device 328, vendor 330, vendor user interface 332, shipper 1 334, shipper n 336, consolidator 338, destination 340, bookings database 342, and vendor application programming interface (API) 344. The system 300 may be implemented, at least in part, by an enterprise seeking to interface with a plurality of vendors to coordinate vendor shipments on the basis of an expected arrival time or date, rather than on a traditional basis of expected date at which an item may be ready for shipment.

In some examples, one or more of server platform 302, monitoring application 304, transportation manager 306, purchase order application, inventory ready date application, database 314, shipping lead time application 320, bookings database 342, user device 322, user 324, and user interface 326, including computer systems associated with these applications, may be associated with or located within an enterprise system (for example, a retail enterprise). In some examples, consolidator 338 (and its associated computing systems) may be associated with and/or located within the enterprise. In some examples, consolidator 338 may be associated with the enterprise, and its computing systems may be located remotely from other computing systems of the enterprise.

In some examples, an enterprise (as described above) may have a server platform 302, which may be an application programming interface (API) in some examples. Server platform 302 may include transportation manager 306. In some examples, server platform 302 may include monitoring application 304; in some examples, monitoring application 304 may reside outside of server platform 302.

In some examples, server platform 302 (and the applications it contains) as well as the other components of system 300 may send and/or receive data via network 308. In some examples, as described herein, network 308 may include a computer network, an enterprise intranet, the Internet, a LAN, a Wide Area Network (WAN), wireless transmission mediums, wired transmission mediums, other networks, and combinations thereof. Although network 308 is shown as a single network in FIG. 3, this is shown as an example and the various communications described herein may occur over the same network or a number of different networks.

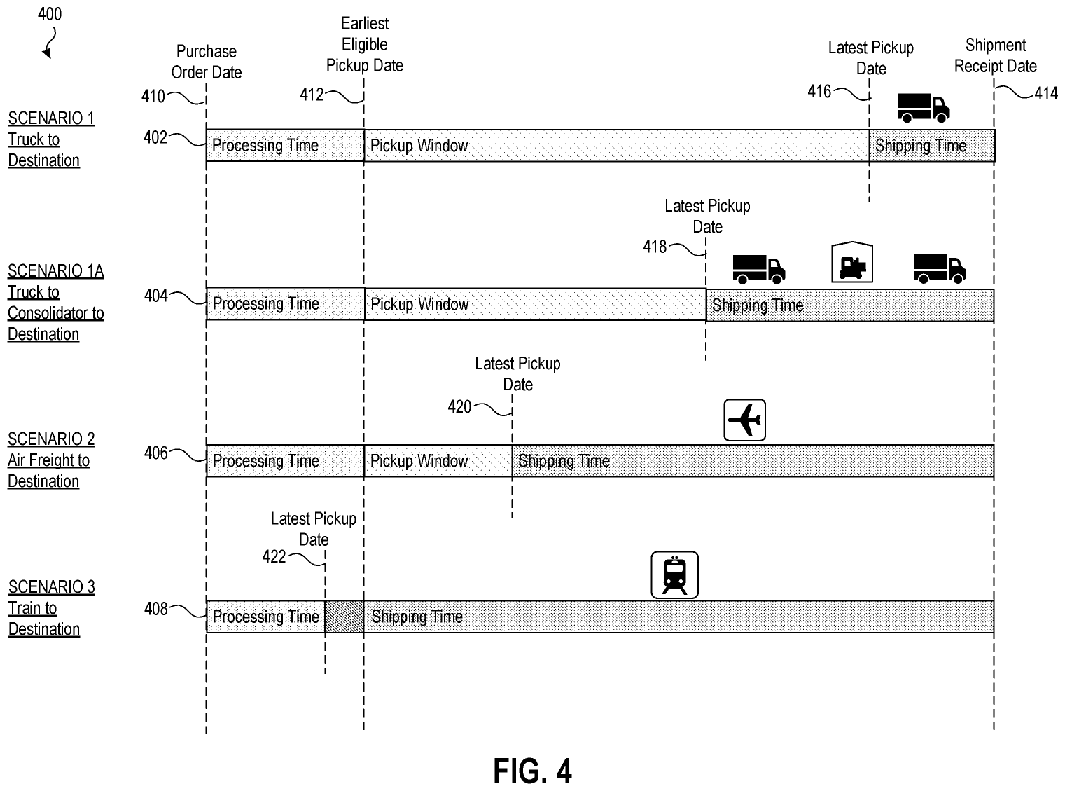

In some examples, transportation manager 306 may receive information, which may include an earliest eligible pickup date (in some examples, called a “ship begin” date), a shipment receipt date (in some examples, called an inventory ready date, or in-yard goal date; which may be defined as the goal date when the shipment is targeted to be received at a destination), a vendor, and a destination. For further description of the dates and input information, refer to FIGS. 4, 5, and 7A. For example, some or all of this information may be received in the form of a purchase order, generated by purchase order application 310. In some examples, this information (individually or as a purchase order) may be received from an enterprise inventory ready date application 312, or for example as calculated at least in part using a lead time calculation application as described in U.S. Pat. No. 11,227,015, entitled “System and Method for Estimating Carrier Transit Times,” the disclosure of which is hereby incorporated by reference in its entirety.

In some examples, purchase order application 310 is an application within the enterprise, which generates purchase orders using information relating to items required to be shipped to a destination 340 from a vendor 330. Each purchase order may define a shipment of items which is to be shipped from a particular vendor to a particular destination. Each purchase order may include some shipment information, including one or more of: vendor, vendor location, consolidator (if necessary), consolidator location, destination, destination location, items, item description, item attributes and parameters, shipping parameters, shipment receipt date, earliest eligible pickup date, and others.

In some examples, shipment data (including vendor, vendor location, consolidator (if necessary), consolidator location, destination, destination location, items, item description, item attributes and parameters, shipping parameters, shipment receipt date, earliest eligible pickup date, and others) is determined from data associated with or included within the purchase order. This determination may include review of the items to be purchased, quantities of items, item or item pack/case dimensions, item weights, destinations, consolidators, vendors, and other data.

In some examples, a shipment receipt date may be determined at an inventory ready date application 312 and may be defined as the last target day that the destination may receive the items (refer also to FIG. 4). In some examples, the shipment receipt date is received at the transportation manager 306 from the inventory ready date application 312. In some examples, the shipment receipt date is received at the purchase order application 310 from the inventory ready date application, where it may be added to a generated purchase order.

In some examples, transportation manager 306 and/or purchase order application 310 may receive information from database 314. Database 314 may include data such as location information 316 (for example, addresses and/or coordinates of destinations, vendors, and/or consolidators) and vendor processing information 318 (for example, vendor contracts and vendor processing times, as discussed regarding FIG. 4 below).

In some examples, shipping lead time application 320 may generate a shipping lead time associated with shipment of an item between origin-destination pairs of the enterprise supply chain (for example, vendor-destination, vendor-consolidator, or consolidator-destination) for each of a particular shipper 1 334 or shipper n 336. An example of determining a shipping lead time is described in U.S. patent Application Publication No. 2020/0111033, the entire disclosure of which is incorporated herein by reference. U.S. patent Application Publication No. 2020/0111033 describes a lead time architecture which may include a lead time aggregator that calculates a lead time estimate to move products/goods (items) between a first node in a supply chain and a second node in the supply chain.

In some examples, shipper 1 334, and shipper n 336 are representative of one or more transportation modes (as described above regarding FIGS. 1 and 2) which may be available to ship items required by the enterprise. Shipper 1 334 and shipper n 336 may be different or the same types of transportation modes. Each of shipper 1 334 and/or shipper n 336 may have associated with it a transportation cost (which may include mileage, fuel, maintenance, salaries, and other costs), a delivery time (which may depend upon factors such as the type of transportation mode, the specific vehicle, traffic conditions, weather conditions, and distance to be traveled), and/or an item capacity (which may depend upon the type of transportation mode, the type of vehicle, and the type of item). Costs, delivery times, and capacities may be received from computing systems of shipper 1 334 and shipper n 336 or from information stored in database 314 (which may be updated periodically with data from computing systems of shipper 1 334 and shipper n 336, in some examples).

In some examples, a consolidator 338 (as described above regarding FIGS. 1 and 2) may have associated with it a location and/or a processing time. In some examples, a consolidator 338 may be configured to receive or ship items by one or more types of shipper 1 334, shipper n 336 (transportation modes). Consolidator location, processing times, and configuration types may be received from computing systems of consolidator 338 or from information stored in database 314 (which may be updated periodically with data from computing systems of consolidator 338, in some examples).

In some examples, a destination 340 (as described above regarding FIGS. 1 and 2) may have an associated location and may be configured to receive or ship items by one or more types of shipper 1 334, shipper n 336 (transportation modes). Destination location and configuration types may be received from computing systems of destination 340 or from information stored in database 314 (which may be updated periodically with data from computing systems of destination 340, in some examples).

In some examples, booking database 342 may include data related to stored outputs of transportation manager 306. In some examples, booking database 342 may include data and information relating to calculated earliest eligible pickup dates, latest pickup dates, pickup windows, and selected optimal transportation modes. In some examples, booking database 342 may include stored notifications and instructions to be transmitted to vendor 330 and shipper 1 334, shipper n 336. In some examples, booking database 342 may include data regarding change requests made by vendor 330 via a user interface 332 and the status of change requests as determined by transportation manager 306. In some examples, bookings database 342 may include reliability performance data relating to vendor 330 and/or shipper 1 334, shipper n 336.

In some examples, monitoring application 304 may receive vendor 330 and/or shipper 1 334, shipper n 336 reliability performance data and vendor 330 change request data (for example, from bookings database 342).

In some examples, user 324 is an enterprise user. In an example, enterprise user 324 is an employee, operator, manager, or other agent of the enterprise. Enterprise user 324 may have a need to initiate the generation of a purchase order, or view any data (for example, stored in bookings database 342. One or more user interfaces 326 may be viewed and interacted with by employee user 324 via enterprise user device 322. In some examples, the one or more user interfaces 326 allow the enterprise user 324 to access, review, or otherwise interact with one or more of the applications/platforms of system 300. In some examples, user interface 326 may include information from a vendor (for example, vendor user 330), including status of a shipment of items. In some examples, user interface 326 may include information relating to communications, notifications, and/or requests from vendor user 330.

In some examples, user 330 is a vendor user. In an example, vendor user 330 is an employee, operator, manager, or other agent of a vendor. In some examples, a vendor (such as described with respects to FIGS. 1 and 2) may view one or more vendor user interfaces 332 via a vendor device 328 (and a vendor computing system, which may include a vendor computing system API). The one or more user interfaces 332 may include user interfaces 332 generated by transportation manager 306 and may include shipment information (including selected transportation mode information) determined by transportation manager 306). In some examples, vendor user 330 may interact with the user interface(s) 332 to accept shipment bookings, reject shipment bookings, or request a change to one or more parameters of a shipment booking. Requested changes may be transmitted to the transportation manager.

In some examples, one or more applications which are associated with the enterprise (for example, which are managed by the enterprise) may selectively allow vendor user interface 332 to be updated (and/or exposed to enterprise data) via a vendor API 344. Through vendor API 344, specific information (for example, data pertaining to the enterprise or a shipment of items) may be selectively exposed to the vendor, for example, by updating user interface 322 which is presented to the vendor user 330 via device 328.

In an example, user interface(s) 326, 332 are web applications. In other examples, user interface(s) 326, 332 are device applications.

In some examples, each of devices 322, 328 may be a desktop computer, a laptop computer, a tablet, a cell phone, a smart TV, a smart wearable device, or other appropriate electronic device which is capable of displaying and facilitating interaction with the user interface(s) 326, 332.

FIG. 4 illustrates example timelines for optimizing shipment scheduling within the context of the system 300 of FIG. 3. FIG. 4 includes four illustrative example timelines, Scenario 1 402, Scenario 1A 404, Scenario 2 406, and Scenario 3 408. These example timelines are examples and are not exhaustive of potential timeline possibilities.

In each of the example timelines, the enterprise may have generated a purchase order to a particular vendor (for example, a vendor as described above with respect to FIGS. 1-3) on a purchase order date 410. The purchase order may define a specific shipment of goods to be shipped from the vendor to a destination.

The destination (for example, a retail store) which requires the shipment of items, may need the items by a defined shipment receipt date 414. The shipment receipt date 414 may be defined as the last target day that the destination may receive the items (or else, for example, the destination may not have the items in stock to begin selling or filling orders to meet market/enterprise needs, etc.).

The particular vendor may have associated with it a processing time. The processing time may be the time it takes the vendor to manufacture, procure, package, and/or otherwise prepare the item for shipment. In some examples, the processing time may vary from purchase order to purchase order. In some examples, the processing time for a particular vendor is a predetermined period of time. In some examples, the processing time may be set in a contract between the vendor and the enterprise. The processing time starts at the purchase order date 410, and the end of the processing time defines the earliest eligible pickup date 412. The earliest eligible pickup date 412 represents the earliest date when a shipper (one as defined in FIG. 3) may pick up the shipment of items from the vendor.

For each scenario, a plurality of transportation modes/shippers may be evaluated to determine which is the appropriate shipper to book for the particular shipment of items. For each transportation mode, a pickup window is determined within which the shipment of items must be picked up from the vendor. Determining which shipping mode to select may be based, at least in part, on whether a shipping mode is capable of delivering the shipment of items to the destination from the vendor by the shipment receipt date.

For example, in Scenario 1 402, the transportation mode evaluated to move the items from the vendor to the destination is a truck (for example, as described in FIGS. 1-3). The truck has associated with it a shipping time. To calculate the pickup window for the truck, the shipping time is subtracted from the shipment receipt date 414 to calculate a latest pickup date 416, which represents the latest pickup date that the truck could pick up the items from the vendor in order to deliver the items to the destination by the shipment receipt date 414. The pickup window is defined at an earliest end by the earliest eligible pickup date 412 and at a latest end by the latest pickup date 416. If the truck picks up the items any time during that pickup window, the items should be (barring any unforeseen circumstances which alter the shipping time) delivered to the destination on or before the shipment receipt date 414.

In some examples, the shipping time includes a buffer time period, to take into account historically seen and/or commonly expected delays. In some examples, the shipping time (and/or the buffer time period) is calculated to a certain predicted accuracy or confidence level.

Scenario 1A 404 represents an example where the transportation mode evaluated is a truck which transports the items to a consolidator (for example, as described in FIGS. 1-3), and a truck further transports the items to the destination. Each truck leg and the consolidator have associated with them an individual shipping or processing time, which may be combined to determine an overall shipping time (from vendor to destination). To calculate the pickup window for this example, the shipping time is subtracted from the shipment receipt date 414 to calculate a latest pickup date 418. The pickup window is defined at an earliest end by the earliest eligible pickup date 412 and at a latest end by the latest pickup date 418. If the truck picks up the items any time during that pickup window, the items should be (barring any unforeseen circumstances which alter the shipping time) delivered to the destination on or before the shipment receipt date 414.

In some examples, a two-day buffer duration may be added to the shipping time or subtracted from the latest pickup date 416 (moving the latest pickup date 416 earlier in time) to account for a situation in which the items may not be delivered to the destination on a weekend. In some examples, one or more other buffer durations may be applied (alone or in combination) to account for other situations, including holidays or a situation where a vendor submits a review of shipments late. In the latter situation, the earliest eligible pickup date 412 may be shifted and may be later in time than the shipment receipt date 414. If this situation occurs, another vendor may be selected to provide the items, another carrier may be chosen, and/or the number of days that the earliest eligible pickup date 412 is later than the shipment receipt date 414 may be added to determine an ultimate shipment receipt date.

Scenario 2 406 represents an example where the transportation mode evaluated to move the items from the vendor to the destination is air freight (for example, as described in FIGS. 1-3). The air freight has associated with it a shipping time. To calculate the pickup window for the truck, the shipping time is subtracted from the shipment receipt date 414 to calculate a latest pickup date 420. The pickup window is defined at an earliest end by the earliest eligible pickup date 412 and at a latest end by the latest pickup date 420. If the air freight picks up the items any time during that pickup window, the items should be (barring any unforeseen circumstances which alter the shipping time) delivered to the destination on or before the shipment receipt date 414.

Scenario 3 408 represents an example where the transportation mode evaluated to move the items from the vendor to the destination is rail (for example, as described in FIGS. 1-3). The rail has associated with it a shipping time. To calculate the pickup window for the truck, the shipping time is subtracted from the shipment receipt date 414 to calculate a latest pickup date 422. In this example, the latest pickup date 422 occurs prior to the earliest eligible pickup date. This means there is no pickup window which may be calculated within which the transportation mode (rail, in this particular scenario example) may pick up the item and deliver it to the destination on or before the shipment receipt date 414.

In an example, a transportation mode for which there is no definable pickup window within which the transportation mode may pick up the item and deliver it to the destination on or before the shipment receipt date (the transportation mode is incapable of delivering the shipment of items to the destination from the vendor by the shipment receipt date) will not be selected as a transportation mode for the particular shipment of items.

In the example shown, any of Scenario 1, Scenario 1A, or Scenario 2 depict viable pickup windows. Scenario 3 does not depict a viable pickup window, and so rail would not be selected as the transportation mode for the example shipment of items.

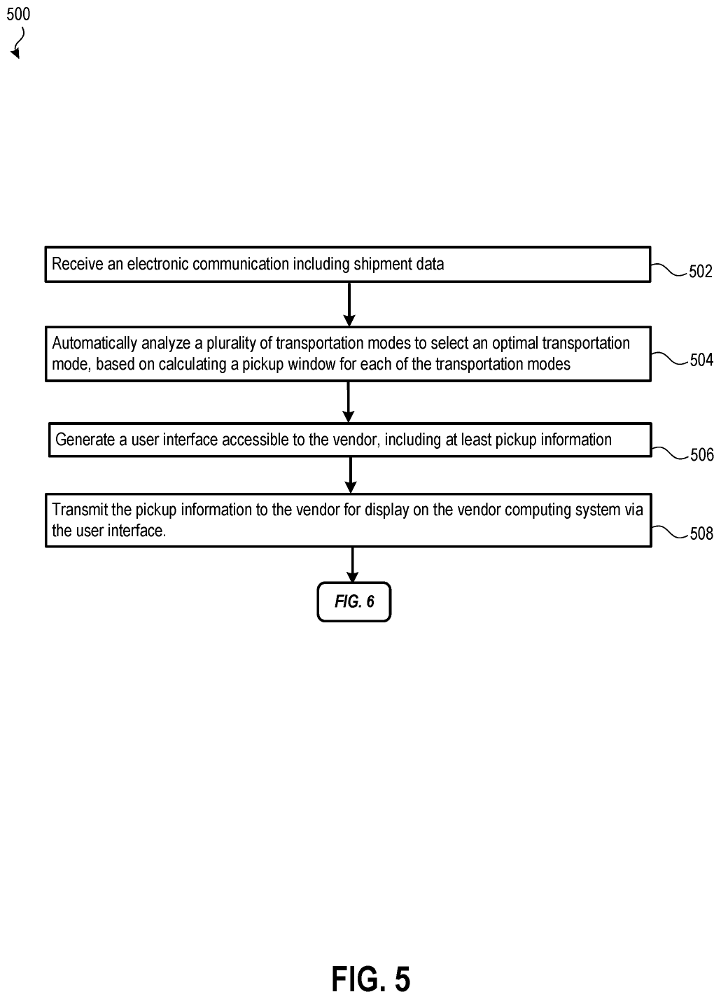

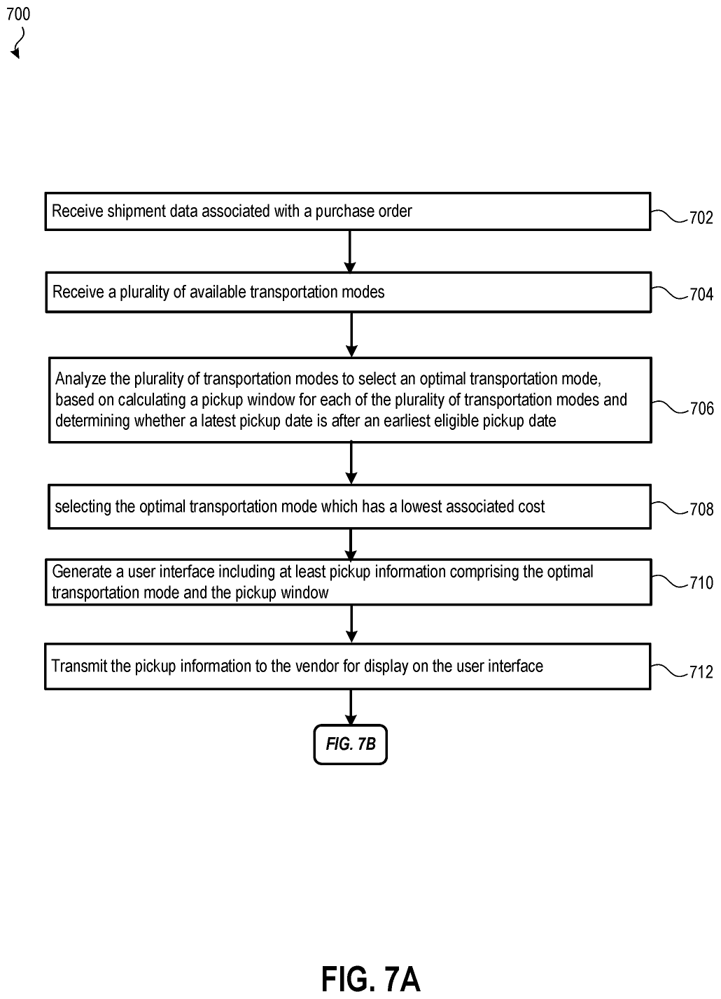

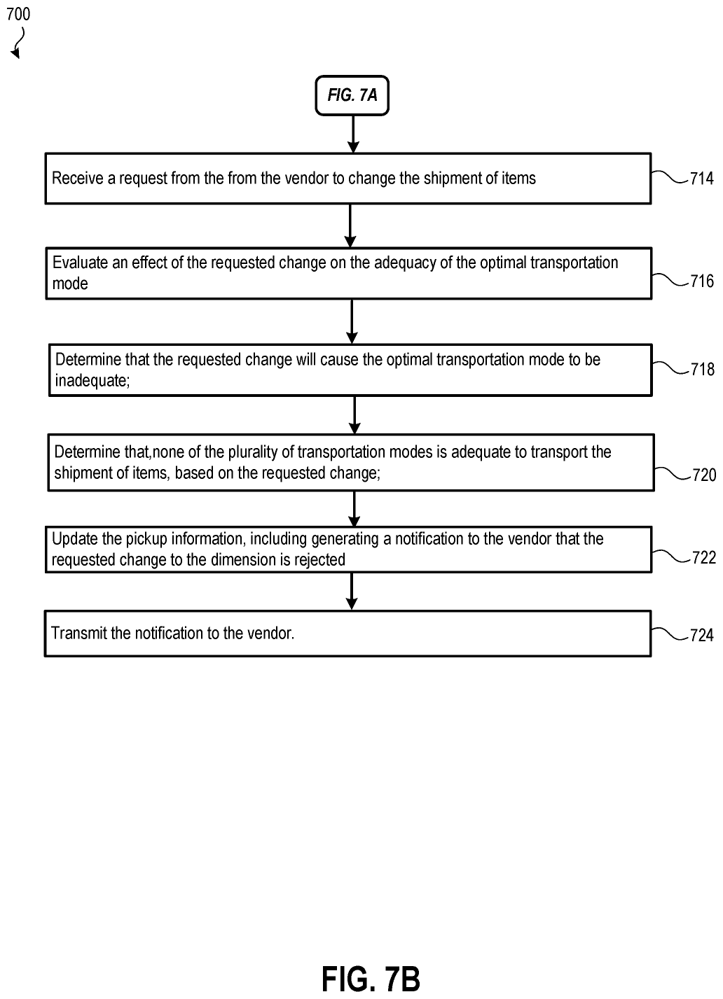

Between the transportation modes which have viable pickup windows, the selected shipping mode may be determined based on various factors, including cost and time, among others. Refer to FIGS. 5 and 7 for additional description of transportation mode selection. For example, if Scenario 2 resulted in a lower shipping cost than Scenario 1 or Scenario 1A, then the transportation mode of Scenario 2 may be chosen to deliver the shipment of items from the vendor to the destination.

FIG. 5 illustrates an example method for optimizing shipment scheduling. The method 500 may be performed by a system for optimizing shipment scheduling as seen in FIG. 3, for example within a supply chain as disclosed above in conjunction with any of FIGS. 1-2.

At step 502, electronic communication(s), including shipment data, may be received. In some examples, the electronic communication may be received by a transportation manager software system such as transportation manager 306, residing within server platform 302 as described above. In some examples, the electronic communication may be received from appropriate data sources and applications as described with respect to FIG. 3. In some examples, the shipment data may be associated with a shipment of items which is to be shipped from a vendor to a destination. In some examples, the shipment data may be associated with a purchase order associated with the shipment of items. In some examples, the purchase order may be generated by a purchase order application (for example, purchase order application 310). In some examples, the shipment data may include an earliest eligible pickup date (for example, as described in FIG. 4), a shipment receipt date (for example, as described in FIG. 4), a vendor (for example, as described in FIGS. 1-3), a destination (for example, as described in FIGS. 1-3), and/or other data relating to the shipment of items.

In some examples, wherein the shipment data may include item handling characteristics associated with the shipment of items. For example, the item handling characteristics may include quantity of items/product, weight of the shipment of items (or individual items), item type, item categories, type of packaging (for example, boxes, crates, pallets, totes, single items, etc.), and/or various shipping considerations (for example, refrigeration, freezing, shock-sensitive, air conditioning required, moisture-sensitive, perishable, etc.).

At step 504, a plurality of transportation modes is automatically analyzed, to select an optimal transportation mode, based at least in part on calculating a pickup window for each of the transportation modes. In some examples, the pickup window (and associated transportation mode analysis and selection) may be calculated by the transportation manager (for example, transportation manager 306). In some examples, each of the plurality of transportation modes has associated with it a cost, a capacity, and/or a shipping time. In some examples, the cost, capacity, and/or shipping times may be received from a shipper (for example, shipper 1 334 or shipper n 336 as described in FIG. 3) and/or a shipping lead time application (for example, shipping lead time application 320 as described in FIG. 3). In some examples, location information may be received (in some examples from at least one database), where the location information may include a destination location and/or a vendor location. In some examples, the shipping time for each of the transportation modes may be based at least in part on the destination location and the vendor location (for example, based on the distance between the two locations and the types of roadways/waterways/airports between the two).

In some examples, selecting the optimal transportation mode is based on determining whether the transportation mode has a viable pickup window (for example, refer to FIG. 4) for delivery of the shipment of items. In some examples, this determination may be based on defining a latest pickup date for each of the plurality of transportation modes; calculating a pickup window for each of the transportation modes; and determining whether the latest pickup date is after the earliest eligible pickup date.

In some examples, if it is determined for a particular transportation mode that the latest pickup date is before the earliest eligible pickup date, that transportation mode may be automatically removed from consideration to be selected as the optimal transportation mode, prior to the step of selecting the optimal transportation mode which has a lowest associated cost (described below).

In some examples, selecting the transportation mode includes determining whether the shipment of items is required to pass through a consolidator facility (for example, refer to FIGS. 1 through 4). Passage through a consolidator facility may affect the shipping time and/or which transportation modes are capable of delivering/carrying the items (for example, whether the consolidator facility can accept or send out that type of transportation mode).

In some examples, the selection of an optimal transportation mode also includes a cost analysis, including selecting, from among each of the transportation modes for which the latest pickup date is after the earliest eligible pickup date, the optimal transportation mode which has a lowest associated cost.

In some examples, selecting the transportation mode includes determining whether each of the transportation modes is adequate to transport the shipment of items, based on the item handling characteristics (weight, size, shipping considerations, etc.). In some examples, transportation modes which are not adequate to transport the shipment of items may be automatically removed (for example by the transportation manager 306) from consideration to be selected as the optimal transportation mode, prior to the step of selecting the optimal transportation mode which has a lowest associated cost.

In some examples, a shipment booking for the shipment of items, including the pickup information (which may include a calculated pickup window and/or a selected transportation mode), may be generated and stored in a bookings database, such as bookings database 342.

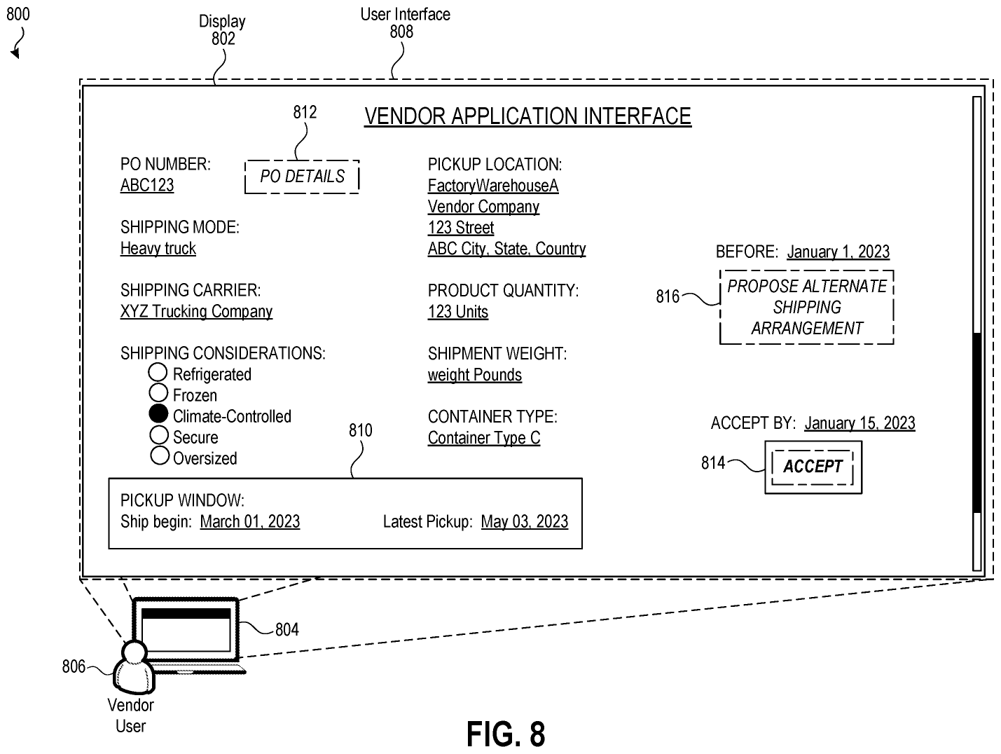

At step 506, a user interface accessible to the vendor is generated. In some examples, the user interface includes at least pickup information (relating to the shipment of items). In some examples, pick up information may include a pickup window. In some examples, the vendor user interface may be as further described with regard to FIGS. 3 and 8.

In some examples, the user interface does not include transportation modes of the plurality of transportation modes for which the latest pickup date is before the earliest eligible pickup date. For example, the user interface may only include information regarding transportation modes, dates, and information relating to the shipment of items which make delivering the shipment of items to the destination on or by the required shipment receipt date feasible.

At step 508, the pickup information is transmitted to the vendor for display on the vendor computing system (for example, vendor devices 328, 804) via the (vendor) user interface. In some examples, the pickup information is transmitted to the vendor automatically. In some examples, the pickup information is transmitted to the vendor in response to a request from a vendor computing system associated with the vendor.

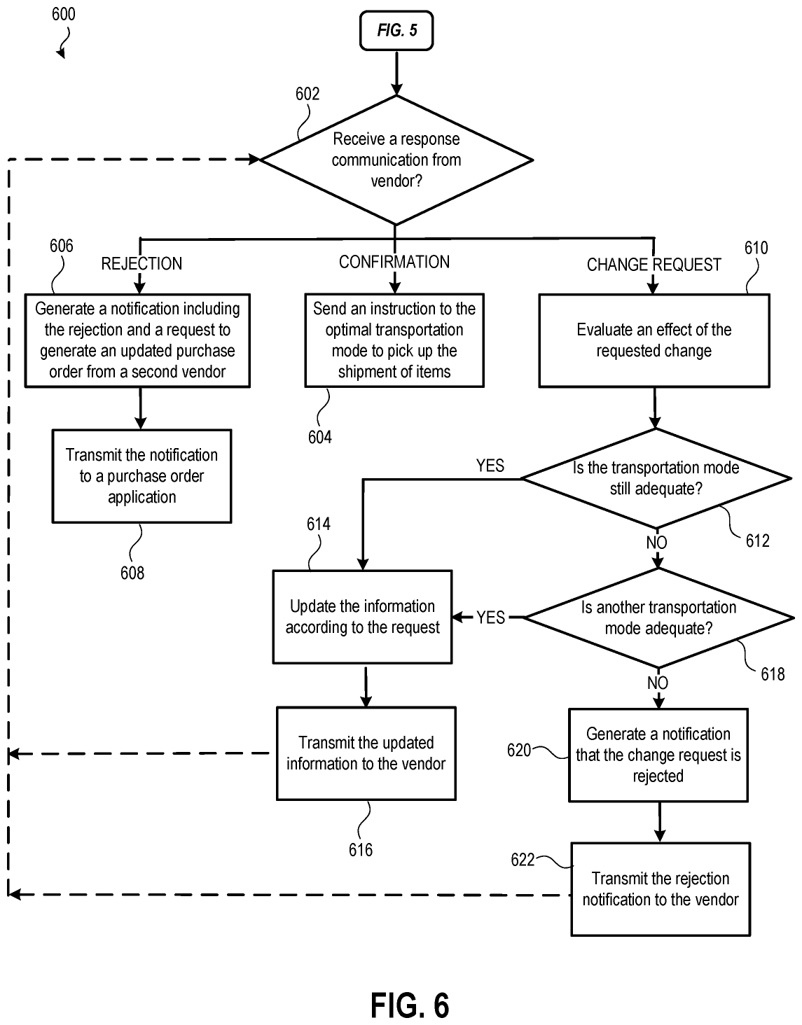

In some examples, the method may continue from FIG. 5 to the method outlined in FIG. 6. FIG. 6 illustrates further the example method for optimizing shipment scheduling. The method 600 may be performed by one or more systems shown and described above, such as the system shown in FIG. 3, for example within a supply chain as disclosed above in conjunction with any of FIGS. 1-2.

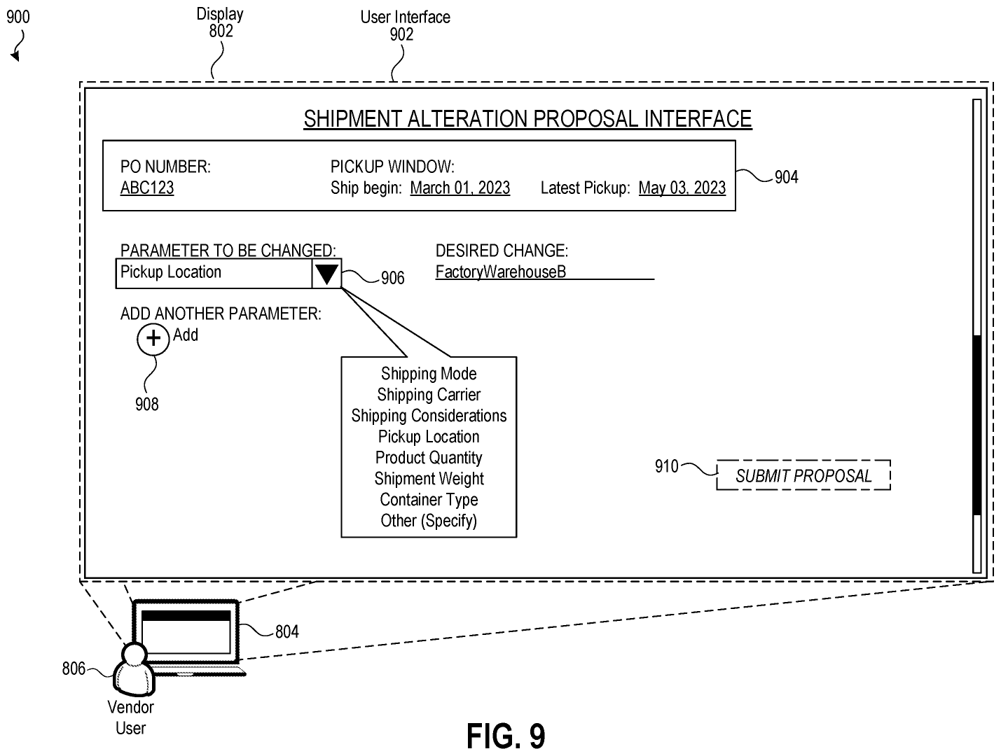

At step 602, a determination is made (for example, by transportation manager 306) whether a response communication (for example, an electronic communication) is received from a vendor (for example, from a vendor computing system). In some examples, the communication may have originated from a vendor user interface, such as those described with regard to FIG. 8 or 9. In some examples, a shipment booking (for example, stored in a shipment bookings database) may be updated to include the response communication.

In some examples, an electronic response communication may include a confirmation from the vendor computing system (in some examples, via the vendor user interface). In some examples, the response may include confirmation that the shipment of items will be ready for shipment within the pickup window. In some examples, the response may include confirmation that the shipment of items will be ready for shipment at a predetermined date within the pickup window. If a confirmation is received, at step 604, an instruction may be sent to the selected transportation mode (for example, shipper 1 334 or shipper n 336) to pick up the shipment of items. In some examples, the instruction sent to the selected transportation mode may indicate that the items are to be picked up on a predetermined date within the pickup window.

In some examples, an electronic response communication may include a rejection from the vendor computing system (in some examples, via the vendor user interface). In some examples, the response may indicate that the vendor is unable or not willing to have the shipment of items ready for shipment within the pickup window. If a rejection is received, at step 606, a notification may be generated which includes the rejection and a request to generate an updated purchase order from a second vendor.

At step 608, the generated notification may be transmitted to a purchase order application (for example, purchase order application 310). Upon receipt of a new purchase order relating to a second shipment of items from a second vendor, the process may re-start at the start of the method outlined in FIG. 5.

In some examples, an electronic response communication may include a change request (received via the vendor user interface, in some examples). In some examples, the change request may include a request to change at least a part of the pickup information. In some examples, the change request may include a request to change one or more item handling characteristics associated with the shipment of items. At step 610, an effect of the requested change may be automatically evaluated (for example, by transportation manager 306). In some examples, the change request (for example, change of at least a part of the pickup information) may have an effect on the latest pickup date. For example, a change in the location of the vendor (for example, a different vendor manufacturing facility) may alter the shipping time required to deliver the item, and therefore may affect the pickup window and the latest pickup date. In some examples, the change request (for example, change of an item handling characteristic) may have an effect on the adequacy of the selected optimal transportation mode. For example, a change in the weight or size of the shipment of items may affect whether or not the selected optimal shipping mode has the capacity or ability to transport the shipment of items.

At step 612, a determination may be made (for example, by transportation manager 306) whether or not the selected optimal transportation mode is still adequate.

In some examples, based on the evaluation, it may be determined that the selected optimal transportation mode is still adequate. For example, it may be determined that a requested change to pickup information will not cause the latest pickup date for the selected transportation mode to be before the ship begin date (there is still a viable pickup window). Similarly, it may be determined that a requested change to one or more item handling characteristics will not cause the selected transportation mode to be inadequate to transport the shipment of items.

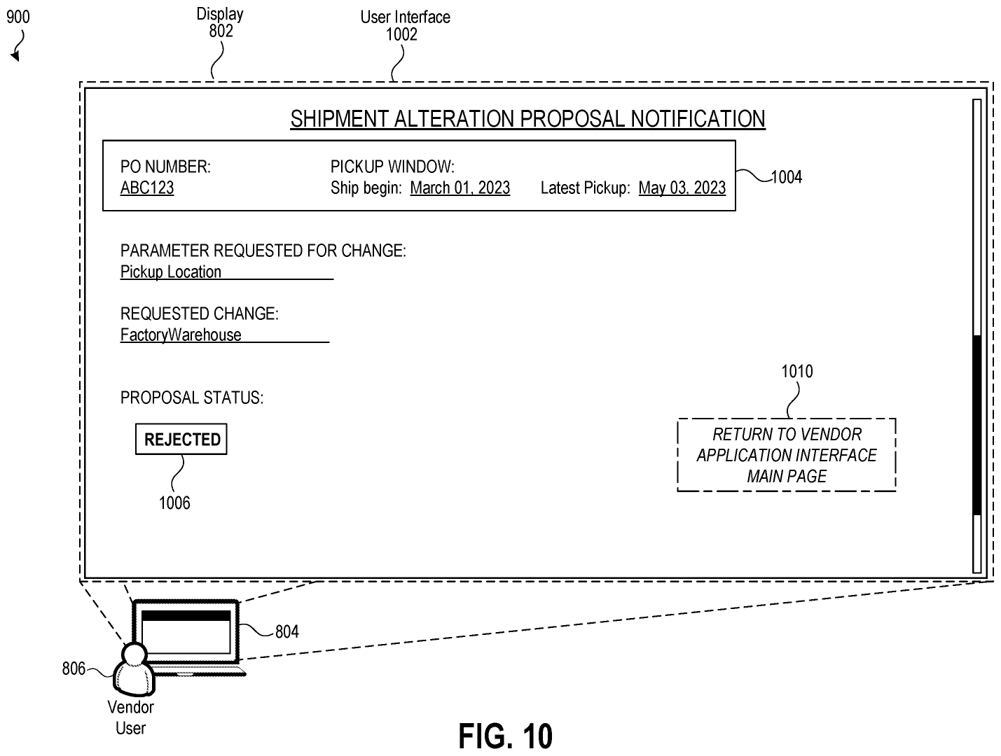

If the optimal transportation mode is still adequate, at step 614 the information may be updated according to the request. For example, the pickup information and/or item handling characteristics (and any other updated information) may be updated according to corresponding requests received via the vendor interface. At step 616, the updated information may be transmitted to the vendor (for example, to be displayed on an updated vendor user interface such as FIG. 10). In some examples, the updated information may be transmitted to the vendor via a vendor application programming interface. In some examples, the method may then return to step 602 if a follow-up response communication is received from the vendor (vendor computing system).

In some examples, based on the evaluation, it may be determined that the selected optimal transportation mode is no longer adequate. For example, it may be determined that a requested change to pickup information will cause the latest pickup date for the selected transportation mode to be before the ship begin date (there is no longer a viable pickup window). Similarly, it may be determined that a requested change to one or more item handling characteristics will cause the selected transportation mode to be inadequate to transport the shipment of items.

If the optimal transportation is no longer adequate, at step 618 it may be determined whether another transportation mode (of the transportation modes for which the latest pickup date was determined to be after the earliest eligible pickup date (the transportation modes having a viable pickup window)) is adequate to transport the shipment of items to the destination.

In an example, a second optimal transportation mode may be selected (for example, by transportation manager 306) which is adequate to transport the shipment of items, based on the changed pickup information and/or changed item handling characteristics. In an example, the second optimal transportation mode may also have a lowest associated cost. If a second adequate optimal transportation mode is available and selected, the method may proceed to step 614, where the information may be updated to reflect the changed pickup information, item handling characteristics, and/or second transportation mode, as necessary.

In some examples, a shipment booking for the shipment of items (for example as stored in a bookings database, such as bookings database 342), may be updated to reflect the changed pickup information, item handling characteristics, and/or second transportation mode.

In an example, if a second transportation mode is selected and subsequently confirmed by the vendor (refer to steps 602, 604), an instruction may be sent to the second selected transportation mode (for example, shipper 1 334 or shipper n 336) to pick up the shipment of items.

In an example, it may be determined that (for example, by transportation manager 306) none of the transportation modes (having a viable pickup window) are adequate to transport the shipment of items, based on the changed pickup information and/or changed item handling characteristics. At step 620, a notification may be generated that the change request is rejected. The pickup information may be updated regarding the notification. At step 622, the notification many be (automatically, in some examples) transmitted to the vendor. In some examples, the updated information may be transmitted to the vendor via a vendor application programming interface. In some examples, the notification may be displayed on the vendor computing system via a vendor user interface such as that described with regards to FIG. 10. In some examples, the method may then return to step 602 if a follow-up response communication is received from the vendor (vendor computing system).

FIG. 7A illustrates an example method for optimizing shipment scheduling. The method 700 may be performed by one or more systems shown and described above, such as the system shown in FIG. 3, for example within a supply chain as disclosed above in conjunction with any of FIGS. 1-2.

At step 702, electronic communication(s) including shipment data, may be received. In some examples, the electronic communication may be received by a transportation manager such as transportation manager 306, residing within server platform 302 as described above. In some examples, the electronic communication may be received from appropriate data sources and applications as described with respect to FIG. 3. In some examples, the shipment data may be associated with a shipment of items which is to be shipped from a vendor to a destination. In some examples, the shipment data may be associated with a purchase order associated with the shipment of items. In some examples, the purchase order may be generated by a purchase order application (for example, purchase order application 310). In some examples, the shipment data may include an earliest eligible pickup date (for example, as described in FIG. 4), a shipment receipt date (for example, as described in FIG. 4), a vendor (for example, as described in FIGS. 1-3), a destination (for example, as described in FIGS. 1-3), one or more item handling characteristics associated with the shipment of items, including a dimension of the shipment of items, and/or other data relating to the shipment of items.

In some examples, item handling characteristics include quantity of items/product, weight of the shipment of items (or individual items), size or dimension of the shipment of items, item type, item categories, type of packaging (for example, boxes, crates, pallets, totes, single items, etc.), and/or various shipping considerations (for example, refrigeration, freezing, shock-sensitive, air conditioning required, moisture-sensitive, perishable, etc.).

At step 704, electronic communication(s) including a plurality of transportation modes may be received (for example, by the transportation manager 306). In some examples, each of the plurality of transportation modes is available to transport the shipment of items from the vendor to the destination.

At step 706, the plurality of transportation modes are analyzed to select an optimal transportation mode. In some examples, the selection of the optimal transportation mode is based, at least in part, on calculating (for example, by transportation manager 306) a pickup window for each of the transportation modes and determining whether a latest pickup date is after an earliest eligible pickup date (also refer to FIG. 4). In some examples, each of the plurality of transportation modes has associated with it a cost, a capacity, and/or a shipping time. In some examples, the cost, capacity, and/or shipping times may be received from a shipper (for example, shipper 1 334 or shipper n 336 as described in FIG. 3) and/or a shipping lead time application (for example, shipping lead time application 320 as described in FIG. 3). In some examples, location information may be received (in some examples from at least one database), where the location information may include a destination location and/or a vendor location. In some examples, the shipping time for each of the transportation modes may be based at least in part on the destination location and the vendor location (for example, based on the distance between the two locations and the types of roadways/waterways/airports between the two).

In some examples, selecting the optimal transportation mode includes defining a latest pickup date for each of the plurality of transportation modes. In some examples, the latest pickup date is defined by subtracting the shipping time from the shipment receipt date. In some examples, a pickup window is calculated for each of the transportation modes. In some examples, the calculation of the pickup window is based on the time between the ship begin date and the latest pickup date. In some examples, it is determined, for each transportation mode, whether the latest pickup date is after the earliest eligible pickup date (i.e. whether there is a viable pickup window; refer also to FIG. 4). In some examples, the pickup window (and associated transportation mode analysis and selection) may be calculated by the transportation manager (for example, transportation manager 306).

In some examples, if it is determined for a particular transportation mode that the latest pickup date is before the earliest eligible pickup date, that transportation mode may be automatically removed from consideration to be selected as the optimal transportation mode, prior to the step of selecting the optimal transportation mode which has a lowest associated cost (described below).

In some examples, selecting the transportation mode includes determining whether each of the transportation modes is adequate to transport the shipment of items, based on the item handling characteristics (weight, size, shipping considerations, etc). In some examples, transportation modes which are not adequate to transport the shipment of items may be automatically removed (for example by the transportation manager 306) from consideration to be selected as the optimal transportation mode, prior to the step of selecting the optimal transportation mode which has a lowest associated cost (as described below).

At step 708, the optimal transportation mode which has a lowest associated cost is selected from among the plurality of transportation modes for which the latest pickup date is after the earliest eligible pickup date.

At step 710, a user interface is generated. In some examples, the user interface includes at least pickup information (relating to the shipment of items). In some examples, pick up information may include the optimal transportation mode and/or a pickup window. In some examples, the vendor user interface may be as further described with regards to FIGS. 3 and 8.

At step 712, the pickup information may be transmitted to the vendor for display on the generated (vendor) user interface. In some examples, pickup information is transmitted to the vendor for display on the vendor computing system (for example, vendor devices 328, 804) via the (vendor) user interface. In some examples, the pickup information is transmitted to the vendor automatically. In some examples, the pickup information is transmitted to the vendor in response to a request from a vendor computing system associated with the vendor.

In some examples, the method may continue from FIG. 7A to the method outlined in FIG. 7B. FIG. 7B illustrates further the example method for optimizing shipment scheduling. The method 700 may be performed by one or more systems shown and described above, such as the system shown in FIG. 3, for example within a supply chain as disclosed above in conjunction with any of FIGS. 1 and 2.

At step 714, an electronic response communication may be received from the vendor. In some examples, the electronic response communication may include a change request (received via the vendor user interface, in some examples) to change the shipment of items. In some examples, the change request may include a request to change the dimensions of the shipment of items. In some examples, the change request may include a request to change the pickup information or to change one or more item handling characteristics associated with the shipment of items.

At step 716, an effect of the requested change on the adequacy of the optimal transportation mode may be automatically evaluated (for example, by transportation manager 306). In some examples, the change request (for example, change of at least a part of the pickup information) may have an effect on the latest pickup date. For example, a change in the location of the vendor (for example, a different vendor manufacturing facility) may alter the shipping time required to deliver the item, and therefore may affect the pickup window and the latest pickup date. In some examples, the change request (for example, change of dimensions of a shipment of items) may have an effect on the adequacy of the selected optimal transportation mode. For example, a change in the weight or size of the shipment of items may affect whether or not the selected optimal shipping mode has the capacity or ability to transport the shipment of items.

At step 718, a determination may be made (for example, by transportation manager 306) whether or not the selected optimal transportation mode is adequate. In some examples, based on the evaluation, it may be determined that the selected optimal transportation mode is no longer adequate. For example, it may be determined that a requested change to one or more item handling characteristics such as dimension of the shipment of items will cause the selected transportation mode to be inadequate to transport the shipment of items.

At step 720, it may be determined whether another transportation mode (of the transportation modes for which the latest pickup date was determined to be after the earliest eligible pickup date (the transportation modes having a viable pickup window)) is adequate to transport the shipment of items to the destination. In an example, it may be determined that (for example, by transportation manager 306) none of the transportation modes (having a viable pickup window) are adequate to transport the shipment of items, based on the requested change.

At step 722, the pickup information may be updated. In some examples, updating the pickup information may include generating a notification to the vendor that the requested change (for example, a change to the dimensions of the shipment of items) is rejected. Refer to FIG. 10.

At step 724, the notification may be automatically transmitted to the vendor. In some examples, the notification may be displayed on the vendor computing system (for example, vendor device 328, 804) via the user interface (for example, vendor user interface 332, 1002). In some examples, the notification may be transmitted to the vendor via a vendor application programming interface.

Referring now to the methods of any of FIGS. 5 through 7B, a reliability performance of the vendor may be monitored (for example, by monitoring application 304). In some examples, reliability performance of the vendor having the shipment ready for pick up on a predetermined date or within the pickup window may be monitored. In some examples, based on the monitored reliability performance of the vendor, a pickup window alteration value associated with the vendor may be calculated. A second pickup window which is calculated for each of the plurality of transportation modes may be adjusted based on the pickup window alteration value. For example, if it is determined via monitoring that a particular vendor usually has items available for shipment a number of days/weeks later than scheduled, a pickup window alteration value may be calculated associated with that vendor which alters future calculated pickup windows (for example, pickup windows as calculated by transportation manager 306) to be offset or altered to take into account the typical number of days/weeks that the vendor is anticipated to be late in shipping the items.

In some examples, it may be determined whether subsequently calculated latest pickup date (based on the altered pickup window) for a future shipment of items is after a subsequently calculated earliest eligible pickup date. In some examples, an optimal transportation mode is selected (from among each transportation mode of the plurality of transportation modes for which the subsequent latest pickup date is after the subsequent earliest eligible pickup date) to transport the future shipment of items. In some examples, the selection may be based, at least on part, on which eligible transportation mode has a lowest associated cost.

FIG. 8 illustrates a vendor user interface, according to an example. In some examples, a display 802 of device 804 may display a user interface 808 (for example, such as vendor user interface 332). The device 804 (for example, such as vendor device 328) may be accessible to a vendor user 806 (for example, a user such as vendor user 330 as described with reference to FIG. 3). User 806 may view information displayed on user interface 808 and may interact with user interface 808 utilizing a keyboard, mouse touchpad, touchscreen, remote, voice command, or other interactive methods. In some examples, the vendor user interface 808 may be generated as described in the methods above and may include shipping information relating to a shipment of items. The vendor user interface 808 may be generated, transmitted to the vendor computing system, and displayed to the vendor after selection of an optimal transportation mode for a shipment of items.

In some examples, (vendor) user interface 808 may be a vendor application interface. User interface 808 may include information relating to a shipment of items, including: a purchase order (PO) number (for example, for a PO relating to the shipment of items from the vendor to the destination); a shipping mode (for example, an optimum shipping mode as determined by the methods outlined above); a shipping carrier (for example, a particular shipper (such as shipper 1 334 or shipper n 336) of the selected shipping mode; shipping considerations (for example, whether the shipment of items must be refrigerated, frozen, climate-controlled, secure, oversized, or other special considerations); pickup location (for example, a vendor or warehouse address or coordinates); a product quantity (for example, a number of individual items or packaged groups of items); a product weight and/or volume; product size/dimensions; a container type (for example, loose, pallet, tote, conex, etc.); and other relevant information.

In some examples, the user interface 808 may include a pickup window 810 (for example as calculated by the methods above). In some examples, user interface 808 may include an earliest eligible pickup (ship begin) date, which may inform the vendor user 806 the earliest date that they could have the shipment of items ready for pickup. In some examples, the user interface 808 may include a latest pickup date, which may inform the vendor user 806 the last date possible for them to have the shipment of items ready for pickup, in order for the selected shipping carrier to deliver the shipment of items to the destination by a required shipment receipt date. In some examples, the user interface 808 may include a more specific or targeted pickup date in addition to or instead of the pickup window.

In some examples, information presented to the user 806 via the user interface 808 may be in the form of text, diagrams, checklists, radio buttons, or other indicators.

In some examples, user interface 808 may include buttons or links to more information. For example, user interface 808 may include button 812 which links the vendor user 806 to another user interface where the vendor user 806 may view additional PO details relating to the shipment of items.

In some examples, user interface 808 may include a button 814 (or other means of interaction) by which the vendor user 806 may accept the information on the vendor application interface. In some examples, this may result in the transmittal of a confirmation communication, as described above with regard to FIG. 6. In some examples, user interface 808 may include a date by which the vendor user 806 is requested to (or must) accept the information as presented.

In some examples, user interface 808 may include a button 816 (or other means of interaction) by which the vendor user 806 may propose a change to the shipping information/shipping arrangement (for example, refer to FIGS. 6 and 7B above). In some examples, this may result in a change request, and may direct the vendor user 806 to another user interface (for example, as described in FIG. 9) to define the change request. In some examples, user interface 808 may include a date by which the vendor user 806 must request a change, if they so desire.

FIG. 9 illustrates a vendor user interface, according to an example. In some examples, a display 802 of device 804 may display a user interface 902 (for example, such as vendor user interface 332). The device 804 (for example, such as vendor device 328) may be accessible to a vendor user 806 (for example, a user such as vendor user 330 as described with reference to FIG. 3). User 806 may view information displayed on user interface 902 and may interact with user interface 902 utilizing a keyboard, mouse touchpad, touchscreen, remote, voice command, or other interactive methods.

In some examples, (vendor) user interface 902 may be a shipment alteration proposal interface. User interface 902 may include information relating to requesting a change to a shipment of items or information relating to the shipment of items. In some examples, the user interface 902 may display relevant summary information 904 relating to the shipment of items, including, for example, a PO number and pickup window (including an earliest eligible pickup (ship begin) date and a latest pickup date).

In some examples, user interface 902 may be configured to allow vendor user 806 to request a change to a shipment of items and related parameters. In some examples, user interface 902 may provide a list of parameters 906 from which the vendor user 806 may choose from to request a change. In some examples, the vendor user 806 may select parameters 906 from a dropdown menu. In some examples, the vendor user 806 may select parameters 906 from a displayed list by clicking on a desired parameter, selecting a radio button, selecting a check-box, or other appropriate means of selection. In some examples, the vendor user 806 may type a parameter in which is not provided in a list. In some examples, parameters 906 which may be changed include a pickup location, shipping mode, shipping carrier, shipping considerations, pickup location, product quantity, shipment weight, container type, or other appropriate parameters. In some examples, one or more of the parameters 906 which may be changed are parameters displayed on vendor application user interface 808 (refer to FIG. 8). In some examples, the user interface 902 includes a means (for example, a text box) for the vendor user 806 to enter/indicate their requested desired change.

In some examples, the vendor user interface 902 may include a button 908 or other interactive means by which the vendor user 806 may add one or more additional/subsequent parameter to be changed. Selection of button 908 may cause the user interface 902 to display an additional list of parameters 906 and area for designating the requested desired change. In some examples, the vendor user interface 902 may include a button 910 or other interactive means by which the vendor user 806 may submit a proposal/change request. This change request may be transmitted (in some examples, from the vendor computing system) to the enterprise system and may be received by an enterprise transportation manager (for example, transportation manager 306) as described above regarding FIGS. 6 and 7B.

FIG. 10 illustrates a vendor user interface, according to an example. In some examples, a display 802 of device 804 may display a user interface 1002 (for example, such as vendor user interface 332). The device 804 (for example, such as vendor device 328) may be accessible to a vendor user 806 (for example, a user such as vendor user 330 as described with reference to FIG. 3). User 806 may view information displayed on user interface 1002 and may interact with user interface 902 utilizing a keyboard, mouse touchpad, touchscreen, remote, voice command, or other interactive methods.

In some examples, (vendor) user interface 1002 may be a shipment alteration proposal notification interface. User interface 1002 may include information relating to a notification of approval or denial of a previously submitted request to change a parameter of a shipment of items. For example, a vendor user 806 may have requested a change via a user interface such as user interface 902. At a transportation manager (such as transportation manager 306), a determination may have been made whether to grant or deny the request, based on whether or not a selected or secondary transportation mode is available that may accommodate the request. As described above in FIGS. 6 and 7B, a notification may have been generated and displayed on a vendor user interface (such as user interface 1002) on the vendor computing system to relay the grant or denial of the request to the vendor user 806.

In some examples, the user interface 1002 may display relevant summary information 1004 relating to the shipment of items, including, for example, a PO number and pickup window (including an earliest eligible pickup (ship begin) date and a latest pickup date).

In some examples, the user interface 1002 may display the parameter which was requested to be changed and what the requested change was. In some examples, the user interface 1002 may display a proposal status 1006 (for example, accepted or rejected, or similar language). In some examples, more than one parameter may have been requested to change. In such an example, user interface 1002 may display information and a proposal status 1006 for each requested parameter, or for all parameters as one larger request. In some examples, all requested changes may be accepted, all requested changes may be rejected, or some requested changes may be accepted and others rejected.

In some examples, user interface 1002 may include a button 1010 or other interactive feature for the vendor user 806 to acknowledge the notification. In some examples, button 1010 may direct the vendor user 806 back to a vendor application user interface 808 (refer to FIG. 8). In an example where the requested change was rejected, no changes may be displayed on the vendor application user interface 808. In an example where at least one requested change was accepted, the changed parameter(s) may be updated and displayed on the vendor application user interface 808. For example, a determination may have been made (for example, by a transportation manager 306 a described in FIG. 6) that a selected or subsequent transportation mode is adequate to accommodate the change request, and the shipment information may have been accordingly updated to incorporate the requested change. This updated shipment information may be transmitted to the vendor computing system and displayed on the generated updated vendor application user interface 808.

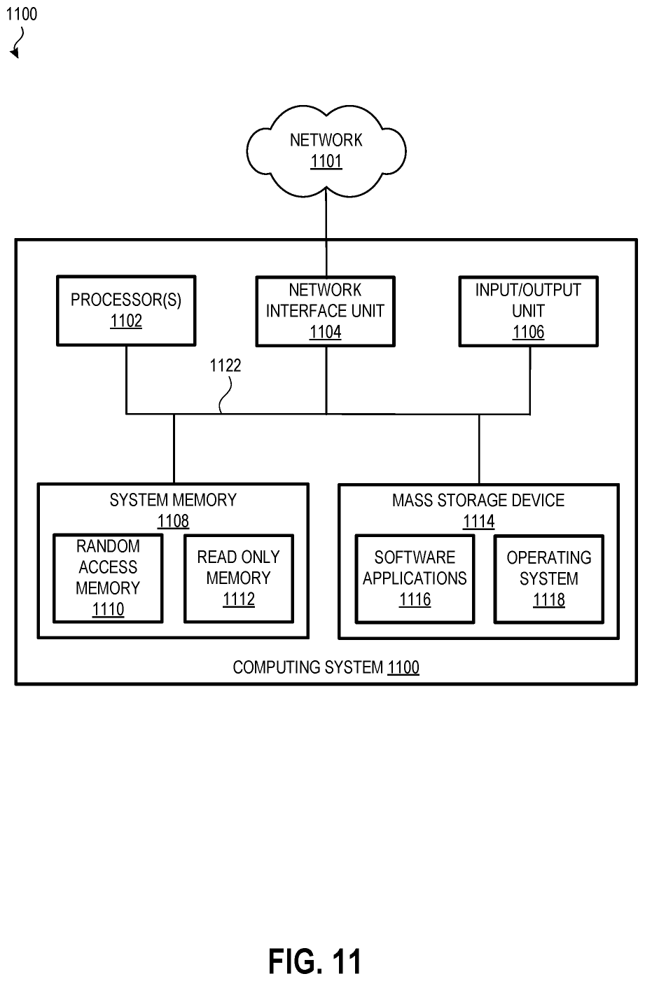

FIG. 11 illustrates an example block diagram of a virtual or physical computing system 1100. One or more aspects of the computing system 1100 can be used to implement the server platform 302, store instructions described herein, and preform operations described herein.

In the embodiment shown, the computing system 1100 includes one or more processors 1102, a system memory 1108, and a system bus 1122 that couples the system memory 1108 to the one or more processors 1102. The system memory 1108 includes RAM (Random Access Memory) 1110 and ROM (Read-Only Memory) 1112. A basic input/output system that contains the basic routines that help to transfer information between elements within the computing system 1100, such as during startup, is stored in the ROM 1112. The computing system 1100 further includes a mass storage device 1114. The mass storage device 1114 is able to store software instructions and data. The one or more processors 1102 can be one or more central processing units or other processors.

The mass storage device 1114 is connected to the one or more processors 1102 through a mass storage controller (not shown) connected to the system bus 1122. The mass storage device 1114 and its associated computer-readable data storage media provide non-volatile, non-transitory storage for the computing system 1100. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1100.

According to various embodiments of the invention, the computing system 1100 may operate in a networked environment using logical connections to remote network devices through the network 1101. The network 1101 is a computer network, such as an enterprise intranet and/or the Internet. The network 1101 can include a LAN, a Wide Area Network (WAN), the Internet, wireless transmission mediums, wired transmission mediums, other networks, and combinations thereof. The computing system 1100 may connect to the network 1101 through a network interface unit 1104 connected to the system bus 1122. It should be appreciated that the network interface unit 1104 may also be utilized to connect to other types of networks and remote computing systems. The computing system 1100 also includes an input/output controller 1106 for receiving and processing input from a number of other devices, including a touch user interface display screen, or another type of input device. Similarly, the input/output controller 1106 may provide output to a touch user interface display screen or other type of output device.

As mentioned briefly above, the mass storage device 1114 and the RAM 1110 of the computing system 1100 can store software instructions and data. The software instructions include an operating system 1118 suitable for controlling the operation of the computing system 1100. The mass storage device 1114 and/or the RAM 1110 also store software instructions, that when executed by the one or more processors 1102, cause one or more of the systems, devices, or components described herein to provide functionality described herein. For example, the mass storage device 1114 and/or the RAM 1110 can store software instructions that, when executed by the one or more processors 1102, cause the computing system 1100 to receive and execute processes for managing supply chain shipments, and in particular optimizing vendor shipment windows for selective display to vendors.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of managing and coordinating exposure of options for vendors to select specific pickup times that ensure appropriate shipment receipt dates, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A computing system, comprising:
at least one processor; and
at least one memory storing computer-executable instructions for optimizing shipment scheduling, the computer-executable instructions when executed by the at least one processor causing the computing system to:
receive an electronic communication including shipment data associated with a purchase order from a purchase order application, the shipment data being associated with a shipment of items defined on the purchase order, wherein the shipment data comprises one or more of:
an earliest eligible pickup date;
a shipment receipt date;
a vendor; and
a destination;
automatically analyze a plurality of transportation modes to select an optimal transportation mode from the plurality of transportation modes, wherein each of the plurality of transportation modes has associated a cost, a capacity, and a shipping time, wherein selecting the optimal transportation mode is based on:
defining a latest pickup date for each of the plurality of transportation modes, wherein the latest pickup date is defined by subtracting the shipping time from the shipment receipt date;
calculating a pickup window for each of the plurality of transportation modes, wherein the calculation of the pickup window is based on the time between the ship begin date and the latest pickup date;
determining whether the latest pickup date is after the earliest eligible pickup date; and
from among each transportation mode of the plurality of transportation modes for which the latest pickup date is after the earliest eligible pickup date, selecting the optimal transportation mode which has a lowest associated cost;
generate a user interface accessible to the vendor, the user interface including at least pickup information comprising the optimal transportation mode and the pickup window; and
in response to a request from a vendor computing system associated with the vendor, transmit the pickup information to the vendor for display on the vendor computing system via the user interface.

2. The computing system of claim 1, further comprising instructions for:
receiving an electronic confirmation communication from the vendor computing system via the user interface that the shipment of items will be ready for shipment at a predetermined date within the pickup window; and
sending an instruction to the selected transportation mode to pick up the shipment of items on the predetermined date.

3. The computing system of claim 1, further comprising instructions for:
receiving a request from the vendor computing system via the user interface to change at least a part of the pickup information;
automatically evaluating an effect of the requested change on the latest pickup date;
determining, based on the evaluation, that the requested change to the pickup information will not cause the latest pickup date for the selected transportation mode to be before the ship begin date;
updating the pickup information according to the request; and
transmitting the updated pickup information to the vendor for display on the vendor computing system via the user interface.

4. The computing system of claim 1, wherein selecting the transportation mode from the plurality of transportation modes further comprises determining whether the shipment of items is required to pass through a consolidator facility.

5. The computing system of claim 1, further comprising instructions for:
receiving location information from at least one database, wherein the location information includes a destination location and a vendor location, wherein the shipping time for each of the plurality of transportation modes is based at least in part on the destination location and the vendor location.

6. The computing system of claim 1, wherein the shipment data further comprises item handling characteristics associated with the shipment of items,
wherein selecting the transportation mode from the plurality of transportation modes further comprises determining whether each of the transportation modes is adequate to transport the shipment of items, based on the item handling characteristics, and
wherein the computing system further comprises instructions to automatically remove each of the transportation modes which is not adequate to transport the shipment of items from consideration to be selected as the optimal transportation mode, prior to the step of selecting the optimal transportation mode which has a lowest associated cost.

7. The computing system of claim 6, further comprising instructions for:
receiving a request from the from the vendor computing system via the user interface to change one or more of the item handling characteristics associated with the shipment of items;
automatically evaluating an effect of the requested change on the adequacy of the optimal transportation mode;
determining, based on the evaluation, that the requested change to the one or more item handling characteristics will not cause the optimal transportation mode to be inadequate to transport the shipment of items;
updating the item handling characteristics according to the request; and
transmitting the updated item handling characteristics to the vendor, via a vendor application programming interface, for display on the vendor computing system via the user interface.

8. The computing system of claim 6, further comprising instructions for:
receiving a request from the from the vendor computing system via the user interface to change one or more of the item handling characteristics associated with the shipment of items;
automatically evaluating an effect of the requested change on the adequacy of the optimal transportation mode;
determining, based on the evaluation, that the requested change to the one or more item handling characteristics will cause the optimal transportation mode to be inadequate to transport the shipment of items;
from among each transportation mode of the plurality of transportation modes for which the latest pickup date is after the earliest eligible pickup date, selecting a second optimal transportation mode which has a lowest associated cost and which is adequate to transport the shipment of items, based on the changed item handling characteristics;
updating the item handling characteristics according to the request;
updating the pickup information, at least including the second optimal transportation mode; and
transmitting the updated item handling characteristics and updated pickup information to the vendor, via a vendor application programming interface, for display on the vendor computing system via the user interface.

9. The computing system of claim 6, further comprising instructions for:
receiving a request from the from the vendor computing system via the user interface to change one or more of the item handling characteristics associated with the shipment of items;
automatically evaluating an effect of the requested change on the adequacy of the optimal transportation mode;
determining, based on the evaluation, that the requested change to the one or more item handling characteristics will cause the optimal transportation mode to be inadequate to transport the shipment of items;
determining that, from among each transportation mode of the plurality of transportation modes for which the latest pickup date is after the earliest eligible pickup date, none of the plurality of transportation modes is adequate to transport the shipment of items, based on the changed item handling characteristics;
updating the pickup information, wherein updating the pickup information includes generating a notification to the vendor that the requested change is rejected; and
automatically transmitting the notification to the vendor, via a vendor application programming interface, for display on the vendor computing system via the user interface.

10. The computing system of claim 2, further comprising instructions for:
monitoring a reliability performance of the vendor having the shipment ready for pick up on the predetermined date.

11. The computing system of claim 10, further comprising instructions for:
based on the reliability performance of the vendor, calculating a pickup window alteration value associated with the vendor;
adjusting a second pickup window calculated for each of the plurality of transportation modes based on the pickup window alteration value;
determining whether a second latest pickup date is after a second earliest eligible pickup date; and
from among each transportation mode of the plurality of transportation modes for which the second latest pickup date is after the second earliest eligible pickup date, selecting a second optimal transportation mode to transport a second shipment of items, which has a lowest associated cost.

12. The computing system of claim 1, further comprising instructions for:
determining, for at least one of the plurality of transportation modes that the latest pickup date is before the earliest eligible pickup date; and
automatically removing the at least one of the plurality of transportation modes from consideration to be selected as the optimal transportation mode, prior to the step of selecting the optimal transportation mode which has a lowest associated cost.

13. The computing system of claim 1, wherein the user interface does not include transportation modes of the plurality of transportation modes for which the latest pickup date is before the earliest eligible pickup date.

14. A method, comprising:
receiving an electronic communication including shipment data associated with a purchase order from a purchase order application, the shipment data being associated with a shipment of items defined on the purchase order, wherein the shipment data comprises one or more of:
an earliest eligible pickup date;
a shipment receipt date;
a vendor; and
a destination;
automatically analyzing a plurality of transportation modes to select an optimal transportation mode from the plurality of transportation modes, wherein each of the plurality of transportation modes has associated a cost, a capacity, and a shipping time, wherein selecting the optimal transportation mode is based on:
determining whether each of the transportation modes is adequate to transport the shipment of items, based on the item handling characteristics;
for each transportation mode of the plurality of transportation modes which is adequate to transport the shipment of items, defining a latest pickup date, wherein the latest pickup date is defined by subtracting the shipping time from the shipment receipt date;
calculating a pickup window for each of the plurality of transportation modes which is adequate to transport the shipment of items, wherein the calculation of the pickup window is based on the time between the ship begin date and the latest pickup date;
determining whether the latest pickup date is after the earliest eligible pickup date; and
from among each transportation mode of the plurality of transportation modes which is adequate to transport the shipment of items, selecting the optimal transportation mode which has a lowest associated cost;
generating a user interface accessible to the vendor, the user interface including at least pickup information comprising the optimal transportation mode and the pickup window; and
in response to a request from a vendor computing system associated with the vendor, transmitting the pickup information to the vendor for display on the vendor computing system via the user interface.

15. The method of claim 14, further comprising:
receiving an electronic confirmation communication from the vendor computing system via the user interface that the shipment of items will be ready for shipment within the pickup window; and
sending an instruction to the selected transportation mode to pick up the shipment of items.

16. The method of claim 14, further comprising:
receiving an electronic rejection communication from the vendor computing system via the user interface that the shipment of items will not be ready for shipment within the pickup window;
generating a notification including the electronic rejection and a request to generate an updated purchase order including a second vendor; and
transmitting the notification to the purchase order application.

17. The method of claim 14, wherein the shipment data further comprises item handling characteristics associated with the shipment of items,
wherein selecting the transportation mode from the plurality of transportation modes further comprises determining whether each of the transportation modes is adequate to transport the shipment of items, based on the item handling characteristics, and
wherein the method further comprises automatically removing each of the transportation modes which is not adequate to transport the shipment of items from consideration to be selected as the optimal transportation mode, prior to the step of selecting the optimal transportation mode which has a lowest associated cost.

18. The method of claim 17, further comprising:
receiving a request from the from the vendor computing system via the user interface to change one or more of the item handling characteristics associated with the shipment of items;
automatically evaluating an effect of the requested change on the adequacy of the optimal transportation mode;
determining, based on the evaluation, that the requested change to the one or more item handling characteristics will cause the optimal transportation mode to be inadequate to transport the shipment of items;
determining that, from among each transportation mode of the plurality of transportation modes for which the latest pickup date is after the earliest eligible pickup date, none of the plurality of transportation modes is adequate to transport the shipment of items, based on the changed item handling characteristics;
updating the pickup information, wherein updating the pickup information includes generating a notification to the vendor that the requested change is rejected; and
automatically transmitting the notification to the vendor, via a vendor application programming interface, for display on the vendor computing system via the user interface.

19. A computing system, comprising:
at least one processor; and
at least one memory storing computer-executable instructions for optimizing shipment scheduling, the computer-executable instructions when executed by the at least one processor causing the computing system to:
receive a first electronic communication including shipment data associated with a purchase order from a purchase order application, the shipment data being associated with a shipment of items defined on the purchase order, wherein the shipment data comprises one or more of:
an earliest eligible pickup date;
a shipment receipt date;
a vendor;
a destination; and
item handling characteristics associated with the shipment of items, including a dimension of the shipment of items;
receive a second electronic communication including a plurality of transportation modes, wherein each of the plurality of transportation modes is available to transport the shipment of items from the vendor to the destination;
automatically analyze the plurality of transportation modes to select an optimal transportation mode from the plurality of transportation modes, wherein each of the plurality of transportation modes has associated a cost, a capacity, and a shipping time, wherein selecting the optimal transportation mode is based on:
defining a latest pickup date for each of the plurality of transportation modes, wherein the latest pickup date is defined by subtracting the shipping time from the shipment receipt date;
calculating a pickup window for each of the plurality of transportation modes, wherein the calculation of the pickup window is based on the time between the ship begin date and the latest pickup date;
determining whether the latest pickup date is after the earliest eligible pickup date; and
from among each transportation mode of the plurality of transportation modes for which the latest pickup date is after the earliest eligible pickup date, selecting the optimal transportation mode which has a lowest associated cost;
generate a user interface accessible to the vendor, the user interface including at least pickup information comprising the optimal transportation mode and the pickup window;
in response to a request from a vendor computing system associated with the vendor, transmit the pickup information to the vendor for display on the vendor computing system via the user interface;
receive a request from the from the vendor computing system via the user interface to change the dimension of the shipment of items;
automatically evaluate an effect of the requested change on the adequacy of the optimal transportation mode;
determine, based on the evaluation, that the requested change will cause the optimal transportation mode to be inadequate to transport the shipment of items;
determine that, from among each transportation mode of the plurality of transportation modes for which the latest pickup date is after the earliest eligible pickup date, none of the plurality of transportation modes is adequate to transport the shipment of items, based on the requested change;
update the pickup information, wherein updating the pickup information includes generating a notification to the vendor that the requested change to the dimension is rejected; and
automatically transmit the notification to the vendor, via a vendor application programming interface, for display on the vendor computing system via the user interface.

20. The computing system of claim 19, further comprising instructions for automatically removing each of the transportation modes which is not adequate to transport the shipment of items from consideration to be selected as the optimal transportation mode, prior to the step of selecting the optimal transportation mode which has a lowest associated cost.

21. The computing system of claim 19, further comprising instructions for:
determining, for at least one of the plurality of transportation modes, that the latest pickup date is before the earliest eligible pickup date; and
automatically removing the at least one of the plurality of transportation modes from consideration to be selected as the optimal transportation mode, prior to the step of selecting the optimal transportation mode which has a lowest associated cost.
